(19) United States
(12) Patent Application Publication
(10) Pub. No.: US 2021/0062768 A1
(43) Pub. Date: Mar. 4, 2021

(54) EVAPORATED FUEL PROCESSING DEVICE

(71) Applicant: AISAN KOGYO KABUSHIKI KAISHA, Obu-shi (JP)

(72) Inventors: Mariko Yukawa, Nagoya-shi (JP); Yoshihiko Honda, Obu-shi (JP); Naohito Buseki, Obu-shi (JP)

(21) Appl. No.: 17/010,218

(22) Filed: Sep. 2, 2020

(30) Foreign Application Priority Data
Sep. 4, 2019 (JP) 2019-161286

(51) Int. Cl. F02M 25/08

(52) U.S. Cl. CPC F02M 25/0836; F02D 41/0045; F02M 25/089

(57) ABSTRACT

An evaporated fuel processing device configured to supply purge gas into an intake passage through which air to be suctioned into an engine passes. The evaporated fuel processing device may include a canister in which the purge gas including evaporated fuel is generated; a purge pump configured to discharge the purge gas toward the intake passage from the canister; a measurement unit configured to measure a temperature of the purge gas discharged from the purge pump; an estimation unit configured to estimate a temperature of the purge gas to be discharged from the purge pump based on an index other than the temperature measured by the measurement unit; and a controller. The controller may be configured to compare the measured temperature measured by the measurement unit with a reference temperature that is higher by a predetermined degree than the temperature estimated by the estimation unit.

### CROSS REFERENCE TO RELATED APPLICATION(S)

This application claims priority to Japanese Patent Application No. 2019-161286 filed on Sep. 4, 2019, the contents of which are hereby incorporated by reference into the present application.

### TECHNICAL FIELD

The present application relates to an evaporated fuel processing device.

### BACKGROUND

Japanese Patent Application Publication No. 2018-084205 describes an evaporated fuel processing device. This evaporated fuel processing device is provided with a canister in which purge gas including evaporated fuel is generated and a purge pump that discharges the purge gas toward an intake passage from the canister. In the evaporated fuel processing device of Japanese Patent Application Publication No. 2018-084205, a controller determines whether the purge pump is operating normally or not based on a duty cycle related to rotary speed of the purge pump obtained from a main communication circuit.

### SUMMARY

In the configuration of Japanese Patent Application Publication No. 2018-084205, the process for determining whether the purge pump is operating normally may be complicated. The disclosure herein provides art for determining whether a purge pump is operating normally or not by using a characteristic of a canister and a characteristic of the purge pump.

An evaporated fuel processing device disclosed herein may be configured to supply purge gas into an intake passage through which air to be suctioned into an engine passes. The evaporated fuel processing device may comprise a canister in which the purge gas including evaporated fuel is generated; a purge pump configured to discharge the purge gas toward the intake passage from the canister; a measurement unit configured to measure a temperature of the purge gas discharged from the purge pump; an estimation unit configured to estimate a temperature of the purge gas to be discharged from the purge pump based on an index other than the measured temperature measured by the measurement unit; and a controller. The controller may be configured to compare the measured temperature measured by the measurement unit with a reference temperature that is higher by a predetermined degree than the estimated temperature estimated by the estimation unit.

In the canister of the evaporated fuel processing device, the purge gas having a relatively low temperature is generated by an endothermic reaction that occurs when the evaporated fuel is separated and the purge gas is generated. On the other hand, in the purge pump of the evaporated fuel processing device, its temperature does not reach a very high temperature when the purge pump is operating normally, however, its temperature may become significantly high when it is not operating normally. Due to this, when the purge gas at the relatively low temperature is discharged from the purge pump, the temperature of the purge gas discharged from the purge pump does not become very high when the purge pump is operating normally, however, the temperature of the purge gas discharged from the purge pump may become significantly high when the purge pump is not operating normally. Thus, the measured temperature measured by the measurement unit may become significantly high when the purge pump is not operating normally.

Contrary to this, since the estimated temperature estimated by the estimation unit is based on an index other than the measured temperature measured by the measurement unit, the estimated temperature does not become very high even when the purge pump is not operating normally. Due to this, when the measured temperature measured by the measurement is compared with the reference temperature that is based on the estimated temperature estimated by the estimation unit, the measured temperature may become higher than the reference temperature that is based on the estimated temperature when the purge pump is not operating normally. As such, whether the purge pump is operating normally or not can be determined by comparing the measured temperature with the reference temperature. Whether the purge pump is operating normally or not can be determined by using a characteristic of the canister that the temperature of the purge gas becomes relatively low by the endothermic reaction that occurs when the evaporated fuel is separated and a characteristic of the purge pump that the pump temperature becomes significantly high when the purge pump is not operating normally.

The evaporated fuel processing device may further comprise a notification unit. When the measured temperature is higher than or equal to the reference temperature, the controller may be configured to cause the notification unit to notify information indicating that the measured temperature is higher than or equal to the reference temperature. According to this configuration, the measured temperature being higher than or equal to the reference temperature can be notified to a user. Due to this, the user can be notified that the purge pump is not operating normally.

When the measured temperature is lower than the reference temperature, the controller may be configured to cause the notification unit to notify of information indicating that the measured temperature is lower than the reference temperature. According to this configuration, the measured temperature being lower than the reference temperature can be notified to the user. Due to this, the user can be notified that the purge pump is operating normally.

The estimation unit may be configured to estimate a temperature of the purge gas to be suctioned into the purge pump from the canister based on an outside air temperature and a concentration of the purge gas to be suctioned into the purge pump, and estimate the temperature of the purge gas to be discharged from the purge pump based on the estimated temperature of the purge gas to be suctioned.

The temperature of the purge gas to be discharged from the purge pump can be estimated based on the temperature of the purge gas to be suctioned into the purge pump. In the estimation for the temperature of the purge gas to be discharged, a consideration may be given to measuring the temperature of the purge gas to be suctioned into the purge pump by a temperature sensor, for example. However, providing the temperature sensor, for example, immediately upstream of the purge pump for measuring the temperature of the purge gas to be suctioned into the purge pump may complicate the configuration of the evaporated fuel processing device. According to the above configuration, the temperature of the purge gas to be suctioned into the purge pump is estimated based on the outside air temperature and the concentration of the purge gas, thus the temperature sensor for measuring the temperature of the purge gas to be suctioned into the purge pump does not need to be provided. Due to this, the temperature of the purge gas to be discharged from the purge pump can be estimated with a simple configuration.

The controller may be configured to stop the purge pump when the measured temperature is higher than or equal to the reference temperature.

According to this configuration, the purge pump can be suppressed from reaching an even higher temperature.

The canister may comprise a pump housing that houses the purge pump.

According to this configuration, the purge gas generated in the canister can be suctioned directly into the purge pump. Due to this, heat generated in the purge pump can be immediately reflected on the purge gas generated in the canister. The heat generated in the purge pump can be reflected on the relatively low-temperature purge gas generated in the canister before the temperature of the purge gas reaches a high temperature by other factors.

The measurement unit may be disposed immediately downstream of the purge pump and may be configured to measure a temperature of the purge gas that has just been discharged from the purge pump.

According to this configuration, the temperature of the purge gas discharged from the purge pump can be measured directly by the measurement unit. The temperature of the purge gas can be measured by the measurement unit before the temperature of the purge gas discharged from the purge pump drops.

The purge pump may comprise a heat transfer member configured to transfer heat generated in the purge pump to the purge gas.

According to this configuration, the heat generated in the purge pump can be surely transferred to the purge gas. Due to this, the temperature of the purge gas discharged from the purge pump becomes significantly high when the purge pump is not operating normally.

The purge pump may comprise a suction port for suctioning the purge gas, a discharge port for discharging the purge gas, and a gas passage positioned between the suction port and the discharge port. The heat transfer member may comprise a heat radiation part facing the gas passage.

According to this configuration, the heat generated in the purge pump can be surely transferred from the heat radiation part of the heat transfer member to the purge gas that passes through the gas passage. Thus, the heat generated in the purge pump can be surely transferred to the purge gas.

The purge pump may comprise a motor and a bearing which supports a rotation shaft of the motor. The heat transfer member may comprise a heat receiving part facing the bearing.

When the purge pump is not operating normally, the bearing supporting the rotation shaft of the motor of the purge pump may reach a high temperature. According to the above configuration, the heat receiving part of the heat transfer member receives heat generated in the bearing when the purge pump is not operating normally. The heat received by the heat receiving part can surely be transferred to the purge gas via the heat transfer member. As such, the heat generated in the purge pump can surely be transferred to the purge gas.

The heat receiving part may face a coil of the motor.

When the purge pump is not operating normally, the coil of the motor of the purge pump may reach a high temperature. According to the above configuration, the heat receiving part of the heat transfer member receives heat generated in the coil of the motor when the purge pump is not operating normally. The heat received by the heat receiving part can surely be transferred to the purge gas via the heat transfer member. As such, the heat generated in the purge pump can surely be transferred to the purge gas.

### BRIEF DESCRIPTION OF DRAWINGS

FIG. 1 schematically shows an evaporated fuel processing device of an embodiment;

FIG. 2 schematically shows a canister of the embodiment;

FIG. 3 schematically shows a purge pump of the embodiment (schematically showing a part III of FIG. 2);

FIG. 4 is a cross-sectional view schematically showing a part IV of FIG. 3;

FIG. 5 is a block diagram of an ECU of the embodiment;

FIG. 6 shows a first map according to the embodiment;

FIG. 7 shows a second map according to the embodiment;

FIG. 8 shows a third map according to the embodiment; and

FIG. 9 is a flowchart of an anomaly determination process.

### DETAILED DESCRIPTION

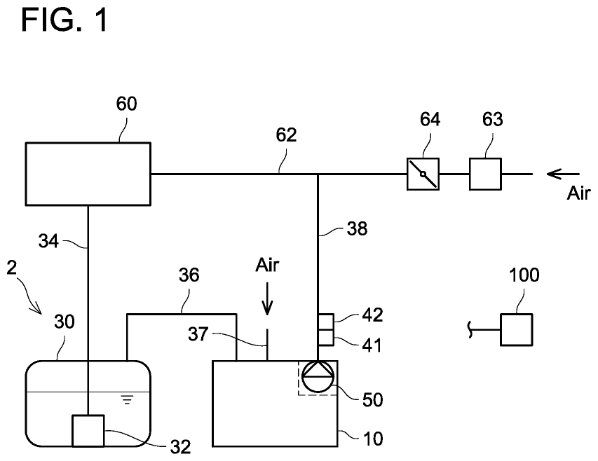

An evaporated fuel processing device of an embodiment will be described. FIG. 1 schematically shows an evaporated fuel processing device 2 of the embodiment. As shown in FIG. 1, the evaporated fuel processing device 2 comprises a fuel tank 30, a canister 10, a purge pump 50, and an Engine Control Unit (ECU) 100. The evaporated fuel processing device 2 is mounted in a vehicle (not shown) such as a gasoline-powered automobile or a hybrid automobile. The vehicle in which the evaporated fuel processing device 2 is mounted further has an engine 60 mounted therein. The evaporated fuel processing device 2 is a device configured to supply purge gas including evaporated fuel generated in the fuel tank 30 to an intake passage 62 connected to the engine 60.

A downstream end of the intake passage 62 is connected to the engine 60 of the vehicle. Air to be suctioned into the engine 60 passes through the intake passage 62. The air is supplied to the engine 60 through the intake passage 62. An air cleaner 63 and a throttle valve 64 are provided on the intake passage 62. The air cleaner 63 is configured to remove foreign matter such as dust included in the air flowing into the intake passage 62. The throttle valve 64 is configured to adjust a flow rate of the air supplied to the engine 60 by adjusting a passage area of the intake passage 62. A purge passage 38 to be described later is connected to a portion of the intake passage 62 downstream of the throttle valve 64.

The fuel tank 30 is configured to store fuel (such as gasoline) to be supplied to the engine 60. A fuel pump 32 is provided within the fuel tank 30. An upstream end of a fuel supply passage 34 is connected to the fuel pump 32. A downstream end of the fuel supply passage 34 is connected to the engine 60. The fuel pump 32 is configured to suction the fuel stored in the fuel tank 30 and discharge the same to the fuel supply passage 34. The fuel discharged from the fuel pump 32 is supplied to the engine 60 through the fuel supply passage 34.

The fuel in the fuel tank 30 may evaporate within the fuel tank 30. For example, the fuel may evaporate while the vehicle is running or parked. Evaporated fuel is generated by the fuel in the fuel tank 30 evaporating.

An upstream end of a tank passage 36 is connected to an upper portion of the fuel tank 30. The evaporated fuel generated in the fuel tank 30 flows into the tank passage 36. A downstream end of the tank passage 36 is connected to the canister 10. The evaporated fuel generated in the fuel tank 30 is supplied to the canister 10 through the tank passage 36.

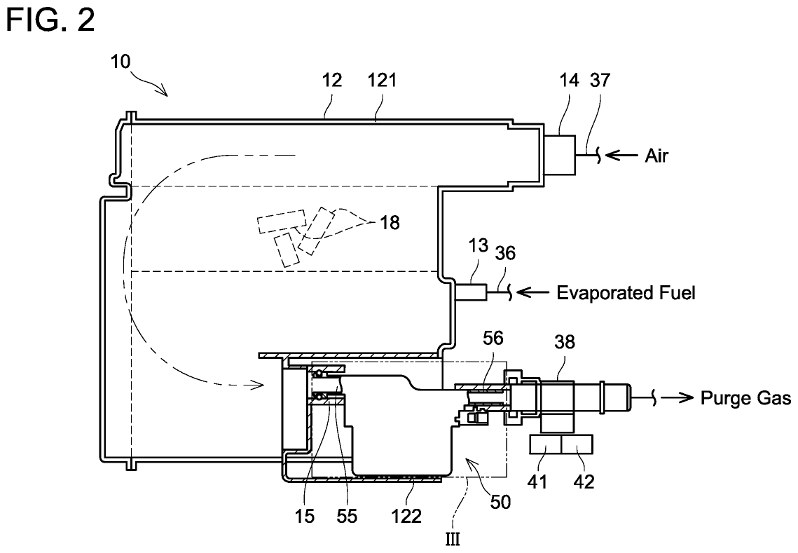

FIG. 2 schematically shows the canister 10 of the embodiment. As shown in FIG. 2, the canister 10 is provided with a case 12, a tank port 13, an open air port 14, and a purge port 15.

The case 12 is provided with a pump housing 122 and an adsorbent member housing 121. The adsorbent member housing 121 houses a plurality of adsorbent members 18 for adsorbing the evaporated fuel supplied to the canister 10. The adsorbent members 18 are constituted, for example, of activated charcoal. When gas containing the evaporated fuel passes through the adsorbent members 18, the evaporated fuel contained in the gas is adsorbed by the adsorbent members 18. Further, when air passes through the adsorbent members 18, the evaporated fuel adsorbed by the adsorbent members 18 is released into the air from the adsorbent members 18 (i.e., the evaporated fuel is purged). The adsorbent members 18 are, for example, in a form of pellets or monolith. For example, coal-based or wood-based activated charcoal may be used as the adsorbent members 18.

The pump housing 122 is fixed to an end of the adsorbent member housing 121. The purge pump 50 is housed in the pump housing 122. The purge pump 50 will be described later. The pump housing 122 surrounds the purge port 15 and the purge pump 50. The pump housing 122 extends in a direction along which the purge port 15 protrudes from the case 12.

The tank port 13, the open air port 14, and the purge port 15 are configured integrally with the case 12. The tank port 13, the open air port 14, and the purge port 15 are fixed to the adsorbent member housing 121 of the case 12. The downstream end of the tank passage 36 (see FIG. 1) is connected to the tank port 13. The evaporated fuel supplied to the canister 10 through the tank passage 36 flows into the adsorbent member housing 121 from the tank port 13. When the evaporated fuel flowed into the adsorbent member housing 121 passes through the adsorbent members 18 housed in the adsorbent member housing 121, the evaporated fuel is adsorbed by the adsorbent members 18.

A downstream end of an open air passage 37 is connected to the open air port 14 of the canister 10. An upstream end of the open air passage 37 is opened to atmosphere (see FIG. 1). Air in the atmosphere is supplied to the canister 10 through the open air passage 37. The air in the atmosphere flows into the adsorbent member housing 121 from the open air port 14. When the air flowed into the adsorbent member housing 121 passes through the adsorbent members 18 housed in the adsorbent member housing 121, the evaporated fuel adsorbed by the adsorbent members 18 is released into the air. Due to this, purge gas containing the evaporated fuel is generated in the adsorbent member housing 121. At this occasion, due to an endothermic reaction that occurs when the evaporated fuel is released, the generated purge gas has a relatively low temperature.

A suction port 55 of the purge pump 50 to be described later is connected to the purge port 15 of the canister 10. The purge gas generated in the adsorbent member housing 121 flows into the purge pump 50 from the purge port 15.

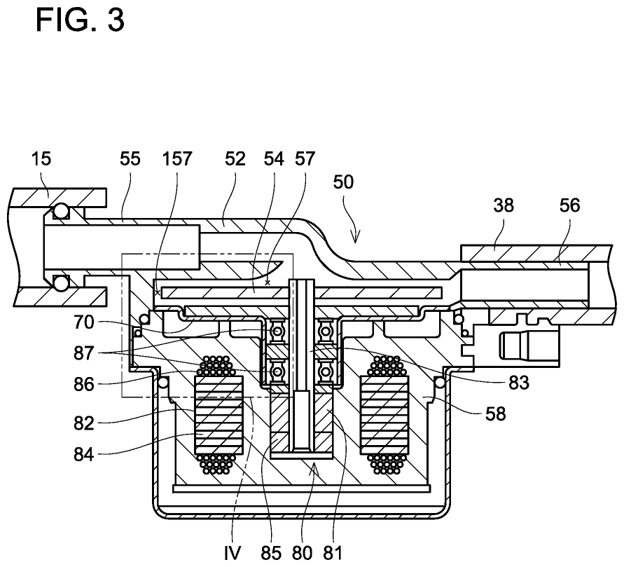

Next, the purge pump 50 will be described. The purge pump 50 is arranged inside the pump housing 122 of the canister 10. FIG. 3 schematically shows the purge pump 50 of the embodiment. As shown in FIG. 3, the purge pump 50 is provided with a housing 52, the suction port 55, a discharge port 56, a motor 80, and an impeller 54.

The housing 52, the suction port 55, and the discharge port 56 are configured integrally. The housing 52 houses the motor 80 and the impeller 54. A gas passage 57 in which the purge gas flows is defined in the housing 52.

The suction port 55 is connected to the purge port 15 of the canister 10. The purge gas that flows out from the purge port 15 flows into the suction port 55. The purge gas flowed into the suction port 55 flows into the gas passage 57 in the housing 52. The gas passage 57 is provided with an impeller housing 157 that houses the impeller 54. The gas passage 57 is defined between the suction port 55 and the discharge port 56. The purge gas that has passed through the gas passage 57 is discharged from the discharge port 56. An upstream end of the purge passage 38 (see FIG. 1) is connected to the discharge port 56. The purge gas discharged from the discharge port 56 flows into the purge passage 38.

The motor 80 of the purge pump 50 may, for example, be a brushless motor. The motor 80 is provided with a stator 82 and a rotor 81. The stator 82 is supported by a support member 58 arranged in the housing 52. The stator 82 includes cores 84 and coils 86 wound around the cores 84. The rotor 81 is provided with a rotation shaft 83 and a permanent magnet 85 arranged around the rotation shaft 83. The rotation shaft 83 is supported by a plurality of bearings 87 arranged in the housing 52. The plurality of bearings 87 is supported by the support member 58. A heat transfer member 70 constituted of metal is arranged between the plurality of bearings 87 and the support member 58.

The impeller 54 of the purge pump 50 is arranged in the impeller housing 157 provided in the housing 52. The impeller 54 is provided with a plurality of blades (not shown). The impeller 54 is fixed to the rotation shaft 83 of the rotor 81. The impeller 54 rotates when the rotation shaft 83 rotates. The purge gas is suctioned into the housing 52 from the suction port 55 of the purge pump 50 when the impeller 54 rotates, and this purge gas flows through the gas passage 57 and is discharged from the discharge port 56. The purge gas that has been discharged from the discharge port 56 flows into the purge passage 38. In the above purge pump 50, heat is generated in the plurality of bearings 87 supporting the rotation shaft 83 when the rotation shaft 83 of the motor 80 rotates. Further, the coils 86 generate heat when the motor 80 operates. The heat generated in the plurality of bearings 87 and the coils 86 is transferred to the heat transfer member 70 arranged in the housing 52.

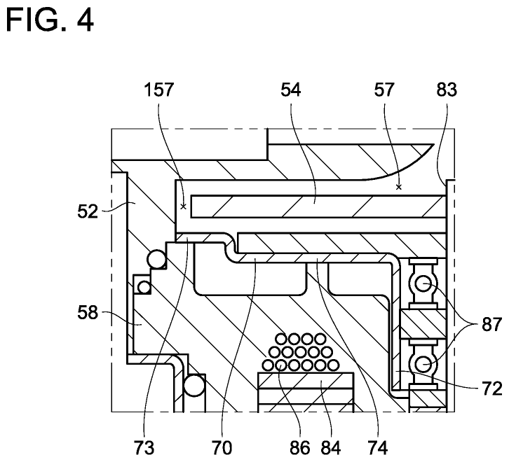

Next, the heat transfer member 70 will be described. FIG. 4 schematically shows a part IV of FIG. 3. As shown in FIG. 4, the heat transfer member 70 is configured by bending a metal plate member. The heat transfer member 70 is provided with a heat receiving part 72, a heat transferring part 74, and a heat radiation part 73.

The heat receiving part 72 is positioned at one end of the heat transfer member 70. The heat receiving part 72 extends along an axial direction of the rotation shaft 83 of the motor 80. The heat receiving part 72 is arranged between the plurality of bearings 87 and the coils 86 of the motor 80 in a radial direction of the rotation shaft 83. One surface of the heat receiving part 72 faces the plurality of bearings 87 and another surface of the heat receiving part 72 faces the coils 86 of the motor 80. The heat receiving part 72 contacts the plurality of bearings 87. The heat receiving part 72 is configured to receive the heat generated in the plurality of bearings 87. Further, the heat receiving part 72 is configured to receive the heat generated in the coils 86 via the support member 58.

The heat transferring part 74 is positioned between the heat receiving part 72 and the heat radiation part 73. One end of the heat transferring part 74 is connected to the heat receiving part 72 and another end of the heat transferring part 74 is connected to the heat radiation part 73. The heat transferring part 74 is configured to transfer the heat which the heat receiving part 72 has received to the heat radiation part 73. The heat transferring part 74 may receive the heat generated in the plurality of bearings 87 and the coils 86 of the motor 80.

The heat radiation part 73 is positioned at another end of the heat transfer member 70 (at the opposite end from the heat receiving part 72). The heat radiation part 73 extends in the radial direction of the rotation shaft 83 of the motor 80. One surface of the heat radiation part 73 faces a part of the impeller housing 157 of the gas passage 57. The surface of the heat radiation part 73 is exposed to the gas passage 57. The heat radiation part 73 is configured to radiate the heat to the purge gas that passes through the gas passage 57. Due to this, the heat generated in the plurality of bearings 87 and the coils 86 of the motor 80 is transferred to the purge gas. The purge gas to which the heat has been transferred is discharged from the purge pump 50.

The upstream end of the purge passage 38 is connected to the purge pump 50. The purge gas that has been discharged from the purge pump 50 flows into the purge passage 38. As shown in FIGS. 1 and 2, a temperature sensor 41 (an example of a measurement unit) and a pressure sensor 42 are provided at the upstream end of the purge passage 38. The temperature sensor 41 and the pressure sensor 42 are arranged immediately downstream of the discharge port 56 of the purge pump 50. The temperature sensor 41 is configured to directly measure a temperature of the purge gas that has just been discharged from the purge pump 50. The pressure sensor 42 is configured to directly measure a pressure of the purge gas that has just been discharged from the purge pump 50. A downstream end of the purge passage 38 is connected to the intake passage 62 (see FIG. 1). The purge gas discharged from the purge pump 50 flows into the intake passage 62 through the purge passage 38.

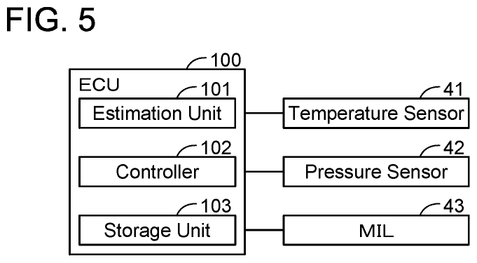

FIG. 5 is a block diagram of the ECU 100 of the embodiment. As shown in FIG. 5, the ECU 100 is connected to the temperature sensor 41, the pressure sensor 42, and an MIL (Malfunction Indication Lamp) 43 via wired connection or wireless connection. The temperature sensor 41 and the pressure sensor 42 are as aforementioned. The MIL 43 (an example of a notification unit) is a lamp configured to notify information related to the evaporated fuel processing device 2. The MIL 43 may, for example, light up in red when the purge pump 50 of the evaporated fuel processing device 2 is not operating normally.

The ECU 100 is provided with an estimation unit 101, a controller 102, and a storage unit 103. The estimation unit 101 is configured to estimate a temperature of the purge gas to be discharged from the purge pump 50 (see FIG. 1). An estimation process executed by the estimation unit 101 will be described later. The controller 102 may, for example, be provided with a CPU, and is configured to execute control and processes related to the evaporated fuel processing device 2. The control and processes executed by the controller 102 will be described later.

The storage unit 103 is provided, for example, with ROM and RAM, and is configured to store information related to the evaporated fuel processing device 2. The storage unit 103 stores a plurality of maps in advance. The storage unit 103 stores a first map, a second map, and a third map. The first to third maps are created in advance based on experiments and/or analyses.

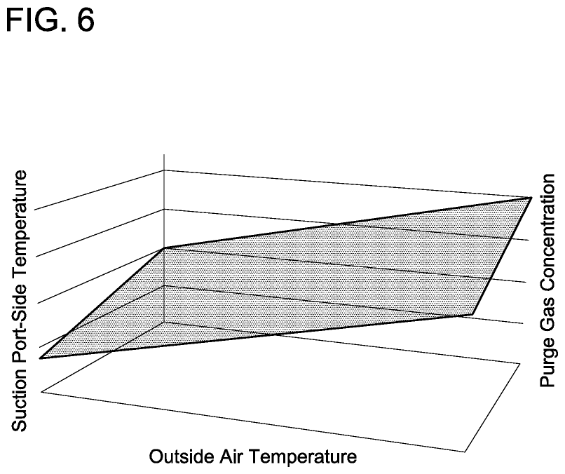

FIG. 6 shows the first map of the embodiment. As shown in FIG. 6, the first map is a three-dimensional map indicating a relationship between an outside air temperature, a concentration of the purge gas, and a suction port-side temperature (i.e., a temperature of the purge gas to be suctioned into the purge pump 50). The first map is a map for estimating the temperature of the purge gas to be suctioned into the purge pump 50 based on the outside air temperature and the concentration of the purge gas. The temperature of the purge gas to be suctioned into the purge pump 50 is a temperature of the purge gas that flows out from the purge port 15 of the canister 10 and flows into the suction port 55 of the purge pump 50. The outside air temperature of the first map is measured, for example, by an outside air temperature sensor (not shown). Further, the concentration of the purge gas is estimated, for example, by the estimation unit 101 of the ECU 100. The estimation unit 101 is configured to estimate the concentration of the purge gas based on the pressure of the purge gas measured by the pressure sensor 42.

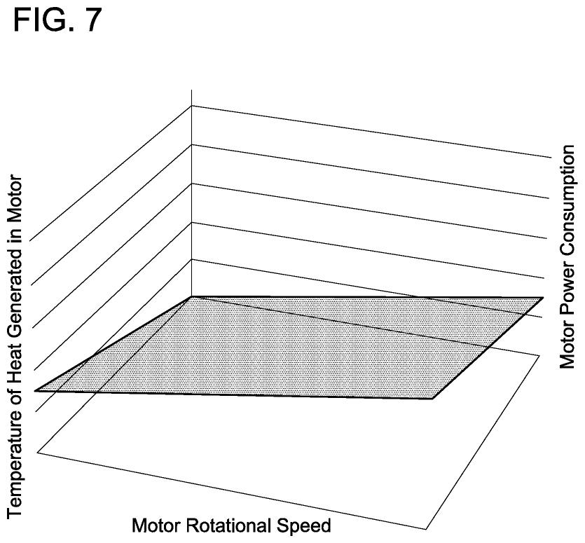

FIG. 7 shows the second map of the embodiment. As shown in FIG. 7, the second map is a three-dimensional map indicating a relationship between a rotational speed of the motor 80 of the purge pump 50, a power consumption of the motor 80 of the purge pump 50, and a temperature of heat generated in the motor 80 of the purge pump 50 in its normal state. The second map is a map for estimating the temperature of heat generated in the motor 80 based on the rotational speed and the power consumption of the motor 80. The rotational speed of the motor 80 is determined, for example, based on a rotational position of the rotor 81 measured by a Hall sensor (not shown). The power consumption of the motor 80 is determined, for example, based on a voltage and current of the motor 80. Methods for determining the rotational speed and the power consumption of the motor 80 are well known, thus detailed description thereof will be omitted.

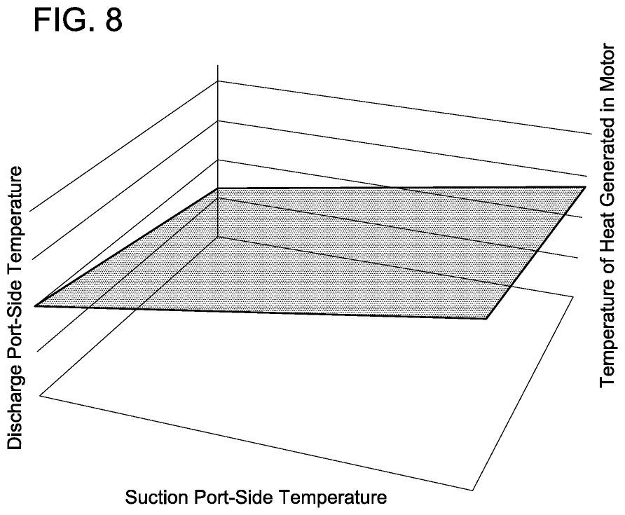

FIG. 8 shows the third map of the embodiment. As shown in FIG. 8, the third map is a three-dimensional map indicating a relationship between the suction port-side temperature (i.e., the temperature of the purge gas to be suctioned into the purge pump 50), the temperature of hat generated in the motor 80 of the purge pump 50 in the normal state, and a discharge port-side temperature (i.e., a temperature of the purge gas to be discharged from the purge pump 50). The third map is a map for estimating the temperature of the purge gas to be discharged from the purge pump 50 based on the temperature of the purge gas to be suctioned into the purge pump 50 and the temperature of heat generated in the motor 80. The temperature of the purge gas to be suctioned into the purge pump 50 is estimated based on the first map as above. The temperature of heat generated in the motor 80 is estimated based on the second map as above.

Next, an operation of the evaporated fuel processing device 2 will be described. In the above evaporated fuel processing device 2, the evaporated fuel generated in the fuel tank 30 shown in FIG. 1 flows into the canister 10 through the tank passage 36. The evaporated fuel flowed into the canister 10 is adsorbed by the plurality of adsorbent members 18 housed in the adsorbent member housing 121 of the canister 10. In the above evaporated fuel processing device 2, when the purge pump 50 starts to operate, the air in the open air flows into the canister 10 through the open air passage 37. When the air flowed into the canister 10 passes through the adsorbent member housing 121, the evaporated fuel adsorbed by the plurality of adsorbent members 18 in the adsorbent member housing 121 is released into the air, and the purge gas is thereby generated. The purge gas generated in the canister 10 is suctioned into the purge pump 50 and then is discharged from the purge pump 50. The purge gas discharged from the purge pump 50 flows into the intake passage 62 through the purge passage 38. The purge gas flowed into the intake passage 62 is supplied to the engine 60 through the intake passage 62.

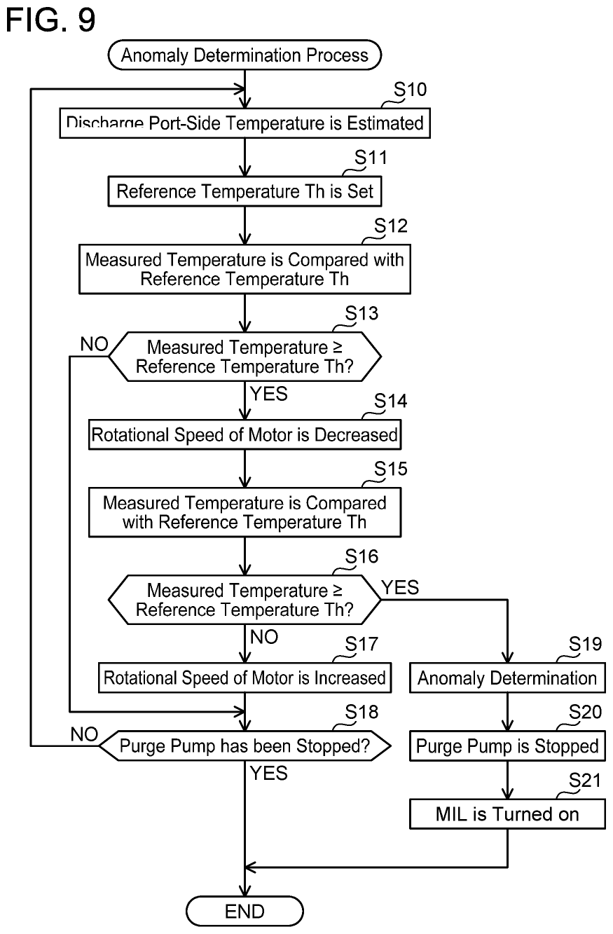

Next, an anomaly determination process executed in the evaporated fuel processing device 2 will be described. FIG. 9 is a flowchart of the anomaly determination process of the embodiment. The anomaly determination process is initiated when the purge pump 50 of the evaporated fuel processing device 2 is actuated, for example. When the purge pump 50 starts operating, the heat is generated in the plurality of bearings 87 and the coils 86 of the motor 80 (see FIGS. 3 and 4) by the rotation of the motor 80 of the purge pump 50.

As shown in FIG. 9, in S10 of the anomaly determination process, the estimation unit 101 of the ECU 100 estimates the discharge port-side temperature (i.e., the temperature of the purge gas to be discharged from the purge pump 50) while the purge pump 50 is operating. More specifically, the estimation unit 101 estimates the suction port-side temperature (i.e., the temperature of the purge gas to be suctioned into the purge pump 50) based on the first map stored in the storage unit 103 (see FIG. 6). Further, the estimation unit 101 estimates the temperature of heat generated in the motor 80 of the purge pump 50 in the normal state based on the second map stored in the storage unit 103 (see FIG. 7). Then, the estimation unit 101 estimates the discharge port-side temperature (i.e., the temperature of the purge gas to be discharged from the purge pump 50) based on the third map stored in the storage unit 103 (see FIG. 8).

In subsequent S11, the controller 102 of the ECU 100 sets a reference temperature Th based on the discharge port-side temperature (i.e., the temperature of the purge gas to be discharged from the purge pump 50) that was estimated by the estimation unit 101 in S10 as above. The reference temperature Th is a temperature that is higher by a predetermined degree than the temperature estimated by the estimation unit 101 in S10 as above. For example, the reference temperature Th is higher by 20° C. than the estimated temperature estimated by the estimation unit 101.

In subsequent S12, the controller 102 compares the reference temperature Th set in S11 as above with the temperature measured by the temperature sensor 41 provided on the purge passage 38. The temperature measured by the temperature sensor 41 is the temperature of the purge gas discharged from the purge pump 50 and is a temperature that is actually measured by the temperature sensor 41.

In subsequent S13, the controller 102 determines whether the measured temperature measured by the temperature sensor 41 is not lower than the reference temperature Th set in S11 as above. In a case where the measured temperature is higher than or equal to the reference temperature Th, the controller 102 determines YES and proceeds to S14. If the measured temperature is lower than the reference temperature Th, the controller 102 determines NO and proceeds to S18 to be described later.

In S14 following YES in S13, the controller 102 decreases the rotational speed of the motor 80 of the purge pump 50. When the rotational speed of the motor 80 decreases, an amount of the purge gas discharged from the purge pump 50 decreases. Further, when the rotational speed of the motor 80 decreases, heat quantity generated in the plurality of bearings 87 and the coils 86 of the motor 80 decreases, by which the temperature of the purge gas discharged from the purge pump 50 may drop.

In subsequent S15, the controller 102 compares the temperature measured by the temperature sensor 41 after the controller 102 having decreased the rotational speed of the motor 80 with the reference temperature Th set in S11 as above.

In subsequent S16, the controller 102 determines again whether the measured temperature measured by the temperature sensor 41 is not lower than the reference temperature Th set in S11 as above. In a case where the measured temperature is higher than or equal to the reference temperature Th, the controller 102 determines YES and proceeds to S19. If the measured temperature is lower than the reference temperature Th, the controller 102 determines NO and proceeds to S17.

In S17 following NO in S16, the controller 102 increases the rotational speed of the motor 80 of the purge pump 50. In subsequent S18, the controller 102 determines whether the purge pump 50 has stopped. For example, when the engine 60 of the vehicle stops, the purge pump 50 stops accordingly. In a case where the purge pump 50 has stopped, the controller 102 determines YES and terminates the anomaly determination process. If the purge pump 50 does not stop, the controller 102 determines NO and returns to S10 as above.

In S19 following YES in S16, the controller 102 determines that an anomaly is occurring in the purge pump 50 (i.e., the purge pump 50 is not operating normally). In subsequent S20, the controller 102 stops the purge pump 50. In subsequent S21, the controller 102 causes the MIL43 to light up in red, for example. After this, when the process of S21 is completed, the anomaly determination process is terminated.

The evaporated fuel processing device 2 of the embodiment has been described above. As it is apparent from the foregoing explanation, the evaporated fuel processing device 2 comprises: the canister 10 in which the purge gas including evaporated fuel is generated; the purge pump 50 configured to discharge the purge gas toward the intake passage 62 from the canister 10; and the temperature sensor 41 configured to measure the temperature of the purge gas discharged from the purge pump 50. The evaporated fuel processing device 2 further comprises the estimation unit 101 configured to estimate the temperature of the purge gas to be discharged from the purge pump 50 based on an index other than the measured temperature measured by the temperature sensor 41 (such as the temperature of the purge gas to be suctioned into the purge pump 50). In the above evaporated fuel processing device 2, the controller 102 is configured to compare the measured temperature measured by the temperature sensor 41 with the reference temperature Th that is higher by the predetermined degree than the estimated temperature estimated by the estimation unit 101.

In the above canister 10, when the purge gas is generated by the evaporated fuel being released, the purge gas with a relatively low temperature is generated by the endothermic reaction. Further, the temperature of the purge pump 50 does not reach a high temperature when it is operating normally, however, when the purge pump 50 is not operating normally, the temperature thereof may become significantly high. For example, the plurality of bearings 87 and the coils 86 of the motor 80 may reach significantly high temperatures. Due to this, when the purge gas at the relatively low temperature is discharged from the purge pump 50, the temperature of the purge gas discharged from the purge pump 50 does not reach a high temperature when the purge pump 50 is operating normally, however, the temperature of the purge gas discharged from the purge pump 50 may reach a significantly high temperature when the purge pump 50 is not operating normally. As such, the measured temperature measured by the temperature sensor 41 may be significantly high when the purge pump 50 is not operating normally.

Contrary to this, since the estimated temperature estimated by the estimation unit 101 is based on the index other than the measured temperature measured by the temperature sensor 41, it does not reach a significantly high temperature even when the purge pump 50 is not operating normally. Due to this, when the measured temperature measured by the temperature sensor 41 is compared with the reference temperature Th that is based on the estimated temperature estimated by the estimation unit 101, the measured temperature may become higher than the reference temperature Th when the purge pump 50 is not operating normally. As such, whether the purge pump 50 is operating normally or not can be determined by comparing the measured temperature with the reference temperature Th. Whether the purge pump 50 is operating normally or not can be determined by using the characteristic of the canister 10 that the temperature of the purge gas upon when the evaporated fuel is released becomes relatively low due to the endothermic reaction that occurs thereupon and the characteristic of the purge pump 50 that the temperature of the purge pump 50 becomes significantly high when the purge pump 50 is not operating normally. Further, whether the purge pump 50 is operating normally or not can be determined without directly measuring the temperature in the purge pump 50 (such as the temperatures of the plurality of bearings 87 and the coils 86 of the motor 80).

Further, in the above evaporated fuel processing device 2, the controller 102 causes the MIL 43 to light up in red in the case where the measured temperature measured by the temperature sensor 41 is higher than or equal to the reference temperature Th (YES in S13 and YES in S16 of FIG. 9). The red light being turned on is an example of information indicating that the measured temperature measured by the temperature sensor 41 is higher than or equal to the reference temperature Th. According to this configuration, the user can be notified that the measured temperature is higher than or equal to the reference temperature Th. Due to this, the user can be notified that the purge pump 50 is not operating normally.

Further, in the above evaporated fuel processing device 2, the estimation unit 101 estimates the suction port-side temperature (i.e., the temperature of the purge gas to be suctioned from the canister 10 into the purge pump 50) based on the outside air temperature and the concentration of the purge gas (see FIG. 6). Further, the estimation unit 101 estimates the discharge port-side temperature (i.e., the temperature of the purge gas to be discharged from the purge pump 50) based on the suction port-side temperature (see FIG. 8).

The suction port-side temperature may, for example, be measured by a temperature sensor. However, providing the temperature sensor immediately upstream of the purge pump 50 for measuring the suction port-side temperature, for example, may complicate the configuration of the evaporated fuel processing device 2. According to the above configuration, since the suction port-side temperature is estimated based on the outside air temperature and the concentration of the purge gas, the temperature sensor for measuring the suction port-side temperature does not need to be provided. Due to this, the temperature of the purge gas to be discharged from the purge pump 50 can be estimated with a simple configuration.

Further, in the above evaporated fuel processing device 2, the controller 102 stops the purge pump 50 in the case where the measured temperature measured by the temperature sensor 41 is higher than or equal to the reference temperature Th (YES in S16, and S20 of FIG. 9). According to this configuration, the purge pump 50 can be suppressed from reaching an even higher temperature.

Further, in the above evaporated fuel processing device 2, the canister 10 comprises the pump housing 122 housing the purge pump 50. According to this configuration, the purge gas generated in the canister 10 can be directly suctioned from the canister 10 into the purge pump 50. Due to this, the heat generated in the purge pump 50 can be immediately reflected on the purge gas generated in the canister 10. The heat generated in the purge pump 50 can be reflected on the relatively low-temperature purge gas generated in the canister 10 before it reaches a high temperature by other factors.

Further, in the above evaporated fuel processing device 2, the temperature sensor 41 is arranged immediately downstream of the purge pump 50 and is configured to measure the temperature of the purge gas discharged from the purge pump 50 at a point immediately downstream thereof. According to this configuration, the temperature of the purge gas discharged from the purge pump 50 can immediately be measured by the temperature sensor 41. The temperature of the purge gas can be measured before the temperature of the purge gas discharged from the purge pump 50 drops.

The purge pump 50 comprises the heat transfer member 70 configured to transfer the heat generated in the purge pump 50 to the purge gas. According to this configuration, the heat generated in the purge pump 50 can surely be transferred to the purge gas. Due to this, the temperature of the purge gas discharged from the purge pump 50 becomes significantly high when the purge pump 50 is not operating normally.

The purge pump 50 comprises the suction port 55 configured to suction the purge gas, the discharge port 56 configured to discharge the purge gas, and the gas passage 57 positioned between the suction port 55 and the discharge port 56. The heat transfer member 70 comprises the heat radiation part 73 facing the gas passage 57. According to this configuration, the heat generated in the purge pump 50 can be surely transferred to the purge gas.

The purge pump 50 comprises the motor 80 and the bearings 87 configured to support the rotation shaft 83 of the motor 80. The heat transfer member 70 comprises the heat receiving part 72 facing the bearings 87. According to this configuration, the heat generated in the bearings 87 when the purge pump 50 is not operating normally can surely be transferred to the purge gas.

The heat receiving part 72 of the heat transfer member 70 faces the coils 86 of the motor 80. According to this configuration, the heat generated in the coils 86 of the motor 80 when the purge pump 50 is not operating normally can surely be transferred to the purge gas.

A specific embodiment has been described above, however, specific configurations of the art disclosed herein are not limited to the above embodiment. In the description below, configurations that are identical to the configurations in the foregoing explanation will be given the same reference signs and description thereof will be omitted.

(1) In the above embodiment, the estimation unit 101 of the ECU 100 estimates the concentration of the purge gas based on the pressure of the purge gas measured by the pressure sensor 42, however, no limitation is made to this configuration. In another embodiment, the estimation unit 101 may estimate the concentration of the purge gas based on a flow rate of the purge gas measured by an ultrasonic flow rate sensor. Alternatively, the estimation unit 101 may estimate the concentration of the purge gas based on an air-fuel ratio of exhaust gas from the engine 60 measured by an Air Fuel (A/F) sensor. In yet another embodiment, the evaporated fuel processing device 2 may comprise a concentration sensor configured to directly measure the concentration of the purge gas.

(2) In another embodiment, the controller 102 may cause the MIL 43 to light up in blue, for example, in a case where the measured temperature measured by the temperature sensor 41 is lower than the reference temperature Th. The controller 102 may cause the MIL 43 to light up in red in a first case where the measured temperature is higher than or equal to the reference temperature Th and may cause the MIL 43 to light up in blue in a second case where the measured temperature is lower than the reference temperature Th. The controller 102 may be configured to turn on the MIL 43 in different colors for the first case and for the second case. The blue light being turned on is an example of information indicating that the measured temperature is lower than the reference temperature Th. According to this configuration, the user can be notified that the measured temperature is lower than the reference temperature Th. Due to this, the user can be notified that the purge pump 50 is operating normally.

(3) In another embodiment, a supercharger configured to compress air and feed the compressed air to the engine 60 may be provided on the intake passage 62. Further, a purge valve configured to switch the purge passage 38 between opened and closed states may be provided on the purge passage 38.

(4) In the above embodiments, the suction port-side temperature (i.e., the temperature of the purge gas to be suctioned into the purge pump 50) is estimated by the estimation unit 101, however, no limitation is made to this configuration. In another embodiment, a temperature sensor may directly measure the suction port-side temperature. In this case, the temperature sensor for measuring the suction port-side temperature is arranged immediately upstream of the suction port 55.

Specific examples of the present disclosure have been described in detail, however, these are mere exemplary indications and thus do not limit the scope of the claims. The art described in the claims include modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. An evaporated fuel processing device configured to supply purge gas into an intake passage through which air to be suctioned into an engine passes, the evaporated fuel processing device comprising:
a canister in which the purge gas including evaporated fuel is generated;
a purge pump configured to discharge the purge gas toward the intake passage from the canister;
a measurement unit configured to measure a temperature of the purge gas discharged from the purge pump;
an estimation unit configured to estimate a temperature of the purge gas to be discharged from the purge pump based on an index other than the measured temperature measured by the measurement unit; and
a controller,
wherein
the controller is configured to compare the measured temperature measured by the measurement unit with a reference temperature that is higher by a predetermined degree than the estimated temperature estimated by the estimation unit.

2. The evaporated fuel processing device according to claim 1, further comprising a notification unit, wherein
when the measured temperature is higher than or equal to the reference temperature, the controller is configured to cause the notification unit to notify information indicating that the measured temperature is higher than or equal to the reference temperature.

3. The evaporated fuel processing device according to claim 2, wherein
when the measured temperature is lower than the reference temperature, the controller is configured to cause the notification unit to notify of information indicating that the measured temperature is lower than the reference temperature.

4. The evaporated fuel processing device according to claim 1, wherein
the estimation unit is configured to estimate a temperature of the purge gas to be suctioned into the purge pump from the canister based on an outside air temperature and a concentration of the purge gas to be suctioned into the purge pump, and estimate the temperature of the purge gas to be discharged from the purge pump based on the estimated temperature of the purge gas to be suctioned.

5. The evaporated fuel processing device according to claim 1, wherein
the controller is configured to stop the purge pump when the measured temperature is higher than or equal to the reference temperature.

6. The evaporated fuel processing device according to claim 1, wherein
the canister comprises a pump housing that houses the purge pump.

7. The evaporated fuel processing device according to claim 1, wherein
the measurement unit is disposed immediately downstream of the purge pump and is configured to measure a temperature of the purge gas that has just been discharged from the purge pump.

8. The evaporated fuel processing device according to claim 1, wherein
the purge pump comprises a heat transfer member configured to transfer heat generated in the purge pump to the purge gas.

9. The evaporated fuel processing device according to claim 8, wherein
the purge pump comprises a suction port for suctioning the purge gas, a discharge port for discharging the purge gas, and a gas passage positioned between the suction port and the discharge port, and
the heat transfer member comprises a heat radiation part facing the gas passage.

10. The evaporated fuel processing device according to claim 8, wherein
the purge pump comprises a motor and a bearing which supports a rotation shaft of the motor, and
the heat transfer member comprises a heat receiving part facing the bearing.

11. The evaporated fuel processing device according to claim 10, wherein the heat receiving part faces a coil of the motor.
